(19) United States
(12) Patent Application Publication
(10) Pub. No.: US 2015/0100265 A1
(43) Pub. Date: Apr. 9, 2015

(54) METHOD FOR COMPENSATING A SIGNAL FROM A PRESSURE MEASUREMENT DEVICE WITHIN AN INTERNAL COMBUSTION ENGINE

(71) Applicants: CONTINENTAL AUTOMOTIVE FRANCE, Toulouse (FR); CONTINENTAL AUTOMOTIVE GmbH, Hannover (DE)

(72) Inventor: Christophe DUCHEMIN, TOULOUSE (FR)

(21) Appl. No.: 14/496,023

(22) Filed: Sep. 25, 2014

(30) Foreign Application Priority Data
Oct. 8, 2013 (FR) 1359758

(51) Int. Cl. G01M 15/08; G01L 7/00

(52) U.S. Cl. CPC G01M 15/08; G01L 7/00
USPC 702/98

(57) ABSTRACT

A method for processing a signal (S_{B}) from a pressure measurement device (D_{P}) in a combustion chamber of a cylinder of an internal combustion engine includes: detecting the start of a plateau phase (S_{P1}); calculating a pair of values of a slope (ax₀, . . . , ax_{N}) and an intercept (bx₀, . . . , bx_{N}) of a straight line approximating the values of the signal acquired by the processing unit during the plateau phase; determining a voltage compensation value of the signal on the basis of each pair of calculated slope and intercept values; compensating the output signal (S_{B}) of the pressure sensor on the basis of the determined voltage compensation value; detecting the start of a voltage peak phase (P2) following the plateau phase (S_{P1}); and, during the detected peak phase, compensating the signal (S_{B}) on the basis of the last pair of slope (ax_{N}) and intercept (bx_{N}) values calculated during the plateau phase.

### FIELD OF THE INVENTION

The present invention relates to the field of pressure measurement in a cylinder of an internal combustion engine and concerns more particularly a device and a method for compensating the drift of an output signal of a pressure measurement sensor.

### BACKGROUND OF THE INVENTION

An internal combustion engine conventionally comprises cylinders in which pistons slide, each defining a combustion chamber in which fuel and an oxidizer are introduced in order to carry out the combustion of the mixture. The engine transforms the energy released by this combustion into mechanical energy.

It is known to equip an internal combustion engine with a device to measure the pressure prevailing within the combustion chambers of the cylinders including pressure measurement sensors and associated electronics.

The value of this pressure enables an electronic computing system (or ECU: “Engine Control Unit”), installed on-board a motor vehicle equipped with an internal combustion engine of this type to adjust in an optimum manner the parameters for regulating said engine, such as the fuel injection parameters or pollutant emission after-treatment parameters.

Pressure measurement sensors of this type may be piezoelectric sensors which, through variations in the electrical charge of the sensitive piezoelectric element subjected to a pressure, provide, in a relative manner, an indication of the pressure prevailing in the cylinder.

A pressure measurement sensor of this type provides an output voltage representing these pressure variations. Generally, the voltage signal supplied by this type of pressure measurement sensor should more or less have the shape of a straight line with a value that is constant, i.e. with a zero slope (for example y=0 Volt), and repeatable, on which voltage peaks are periodically interleaved, representing the pressure peaks which occur within the combustion chamber of the cylinder during the compression and gas combustion phases.

However, this voltage signal is subjected to noise and drift due, inter alia, to the phenomena of pyroelectricity and/or vibrations to which said pressure measurement sensor is subjected. In particular, the heating of the ceramic by the heat released by the combustion of the gases in the cylinder can create a current generating an additional electrical charge in the sensor, referred to as “pyroelectricity”.

In such a case, the signal delivered by the pressure measurement sensor is different from the real curve of the pressure prevailing within the combustion chamber of the cylinder. In particular, outside the pressure peaks, the signal does not have the shape of a constant-value straight line, but, on the contrary, has more or less the shape of a non-zero-slope straight line, i.e. of which the values drift in time, thus creating an offset or drift in relation to a reference value for which the slope of the straight line is zero.

This is shown in FIG. 1. The output signal S_{B} with a voltage V of a pressure measurement sensor according to the time unit t is noisy and drifts according to a straight line with a slope A, offset in relation to a reference value V_{REF} and changing according to the time t, with a value B at t=0 and a value B′>B at t0>0. The signal S_{B} may be equated to an alternation of “plateau” phases S_{P1}, S_{P2}, S_{P3}, during which the voltage is offset in relation to a reference value V_{REF} and changes according to a positive-slope straight line

$$A = \frac{( {B}^{′} - B )}{{t}_{0}}$$

which is more or less linear as a function of time, and voltage peaks P1, P2, P3 representing combustion pressure peaks.

However, a processing of the signal is necessary so that the output voltage signal supplied by a pressure measurement sensor of this type is usable. Here, the pressure measurement device includes, in a known manner, a filter and an algorithm intended to compensate this drift and applied to the voltage signal.

The filter eliminates the noise from the signal and the drift or “offset” compensation algorithm corrects the output signal value in order to prevent this value from deviating from the constant reference value V_{REF}. This filter and this offset correction algorithm are integrated into a processing unit forming part of the pressure measurement device and located in a dedicated integrated circuit or “ASIC” (“Application Specific Integrated Circuit”) associated with and connected to the pressure measurement sensor. The filter and the offset compensation enable the value of the pressure within the combustion chamber of the cylinder to be determined in a precise manner on the basis of the signal processed in this way, and therefore the parameters for regulating the operation of the internal combustion engine to be adjusted proportionally.

A method known from the prior art based on a “Kalman” filter employs a recursive method for correcting errors between the output signal and its prediction attenuated by a gain. The signal prediction is then calculated on the basis of the signal which is filtered and corrected at the preceding acquisition time. More particularly and according to the document FR 2 938 645 A1, it is known to use two Kalman filters: a “fast” Kalman filter, i.e. comprising high-value slope and constant gains for the points belonging to the pressure peaks, and a “slow” Kalman filter, i.e. comprising low-value slope and constant gains for determining the signal drift, i.e. the offset during the plateau phases.

The method described in FR 2 938 645 A1 then corrects each point according to whether or not it belongs to the pressure peaks detected according to the fast Kalman filter and according to the compensation value determined according to the slow Kalman filter. However, the disadvantages of a signal processing method of this type are as follows:
since each point of the signal is processed by a complex calculation using a Kalman filter, a signal processing method of this type is unwieldy and uses a substantial amount of the ASIC circuit memory,
this method is difficult to calibrate, since it comprises four variables to be parameterized: one slope and constant gain for the fast Kalman filter and a different slope gain and a different constant gain for the slow Kalman filter,
at an engine speed below 1000 rpm, the processed signal resulting from this processing method is significantly deformed and therefore difficult to use.

This last case is shown in FIG. 2. The pressure signal S_{K} processed according to the signal processing method described in FR 2 938 645 A1 has a constant pressure reference value of V_{REF}, and no longer drifts in the time t. However, after the pressure peak P_{K}, between the times t0 and t1, this signal processing method creates an underestimation S_{U} of the value of the pressure prevailing in the cylinder in relation to the real curve S_{R}.

The object of the present invention is to overcome these disadvantages by proposing a simple and reliable solution for compensating the drift in the pressure measurements of the gases in a vehicle cylinder.

### SUMMARY OF THE INVENTION

For this purpose, the invention relates to a method for processing a signal from a pressure measurement device in a combustion chamber of a cylinder of an internal combustion engine, said device including:
a pressure measurement sensor supplying an output voltage signal representing the pressure within said combustion chamber, the signal alternately including “plateau” phases during which the voltage changes according to a more or less linear function as a function of time, and voltage peak phases representing pressure peaks in the combustion chamber, and
a processing unit connected to said pressure measurement sensor and configured to acquire periodically a plurality of values of the sensor output voltage signal,
   the method being noteworthy in that it includes the following steps:
a step of detecting the start of a plateau phase on the basis of at least one signal value acquired by the processing unit,
for each signal value at the sensor output acquired during the detected plateau phase:
   a step of calculating a pair of values of a slope and an intercept of a straight line approximating the signal values acquired by the processing unit during the plateau phase,
   a step of determining a signal voltage compensation value on the basis of each pair of calculated slope and intercept values,
   a step of compensating the signal from the pressure sensor on the basis of the determined voltage compensation value,
a step of detecting the start of a voltage peak phase following the plateau phase, and,
during the detected peak phase, a signal compensation step based on the last pair of slope and intercept values calculated during the plateau phase.

And, advantageously, the slope value axₙ and the intercept value bxₙ for a value of the sensor output voltage signal acquired at the time n, where n varies from 0 to N, are given respectively by:

$${ax}_{n} = \frac{12 \times {a}_{n}}{Δ t \times n \times ( n + 1 ) \times ( n + 2 )}$$

with:

$${a}_{n} = {a}_{n - 1} + \frac{n}{2} \times ( {Y}_{n} - {Yavg}_{n - 1} ) and {a}_{0} = 0 , and$$

$${bx}_{n} = {Yavg}_{n} - Δ t \times {ax}_{n} \times \frac{n}{2}$$

where:

$${Yavg}_{n} = \frac{n \times {Yavg}_{n - 1} + {Y}_{n}}{n + 1} with {Yavg}_{o} = {Y}_{o}$$

and where:
Yavgₙ is the mean value of the sensor output voltage signal acquired by the processing unit at the time n,
Yavgₙ is the mean value of the sensor output voltage signal acquired by the processing unit at the time n−1,
Yₙ is the value of the sensor output voltage signal acquired at the time n,
Δt corresponds to the period of acquisition of the voltage signal values at the sensor output by the processing unit.

Thus, the invention allows the signal to be compensated reliably and precisely at each time of the plateau phases and peak phases, notably by using the last pair of slope and intercept values calculated during a plateau phase throughout the peak phase following said plateau phase.

Preferably, the step of calculating a pair of values of a slope and an intercept of a straight line approximating the signal values acquired by the processing unit during the plateau phase is carried out through linear regression, for example by using a least squares method.

A linear regression of this type enables accurate approximation of the slope and intercept values of a straight line corresponding to the plateau phase in order to compensate the sensor output voltage signal, for each time of acquisition of a sensor output voltage signal value, in a reliable and precise manner, notably for the duration of the plateau phase.

The linear regression for the slope and intercept values associated with the acquisition time n is carried out only on the basis of the coefficient values aₙ₋₁ and Yavgₙ₋₁, calculated and stored in advance, and the value of the output voltage signal of the corresponding sensor Yₙ acquired at said time n, which requires little memory space in the acquisition unit and is therefore advantageous.

Moreover, with a linear regression of this type, it is not necessary to store all of the slope and intercept values calculated for each acquisition time of the plateau phase, nor to store all of the values of the output voltage signal of the sensor Yᵢ acquired at the preceding times of the plateau phase (0≦i<n).

Moreover, the compensation is refined as the linear regression calculations are carried out, which is not the case when, for example, the compensation is calculated for a single value of the sensor output voltage signal.

According to one aspect of the invention, the step of compensating the sensor output voltage signal during the detected peak phase is carried out for each time of acquisition of said signal.

According to one characteristic of the invention, the signal values are acquired every 1/804 Hz=1.24 ms.

The invention also relates to a device to measure the pressure in a combustion chamber of a cylinder of an internal combustion engine, for carrying out the previously described method, said device including:
a pressure measurement sensor supplying an output voltage signal representing the pressure within said combustion chamber, the signal alternately including “plateau” phases during which the voltage changes according to a more or less linear function as a function of time, and voltage peak phases representing pressure peaks in the combustion chamber, and
a processing unit connected to said pressure measurement sensor and configured to acquire periodically a plurality of values of the sensor output voltage signal,

the device being noteworthy in that the processing unit is configured in order to:
detect the start of a plateau phase on the basis of at least one signal value acquired by the processing unit,
for each sensor output signal value acquired during the detected plateau phase:
   calculating a pair of values of a slope and an intercept of a straight line approximating the signal values acquired by the processing unit during the plateau phase,
   determining a signal voltage compensation value on the basis of each pair of calculated slope and intercept values,
   compensating the pressure sensor signal on the basis of the determined voltage compensation value,
detecting the start of a voltage peak phase following the plateau phase and, during the detected peak phase,
compensating the signal on the basis of the last pair of slope ax_{N} and intercept values calculated during the plateau phase.

The invention finally relates to a vehicle, notably a motor vehicle, including a device of this type.

### BRIEF DESCRIPTION OF THE DRAWINGS

Other characteristics and advantages of the invention will become evident from the description that follows in relation to the attached figures, given as non-limiting examples and in which identical references are given to similar objects.

FIG. 1, already discussed, shows the signal at the sensor output without the signal processing method,

FIG. 2, already discussed, shows the signal processed by the signal processing method of the prior art,

FIG. 3 is a schematic view showing the cylinder pressure measurement device according to the invention,

FIG. 4 shows schematically the sensor output signal before processing,

FIG. 5 shows an example of an application of the method according to the invention,

FIG. 6 shows the first signal processed by the signal processing method according to the invention.

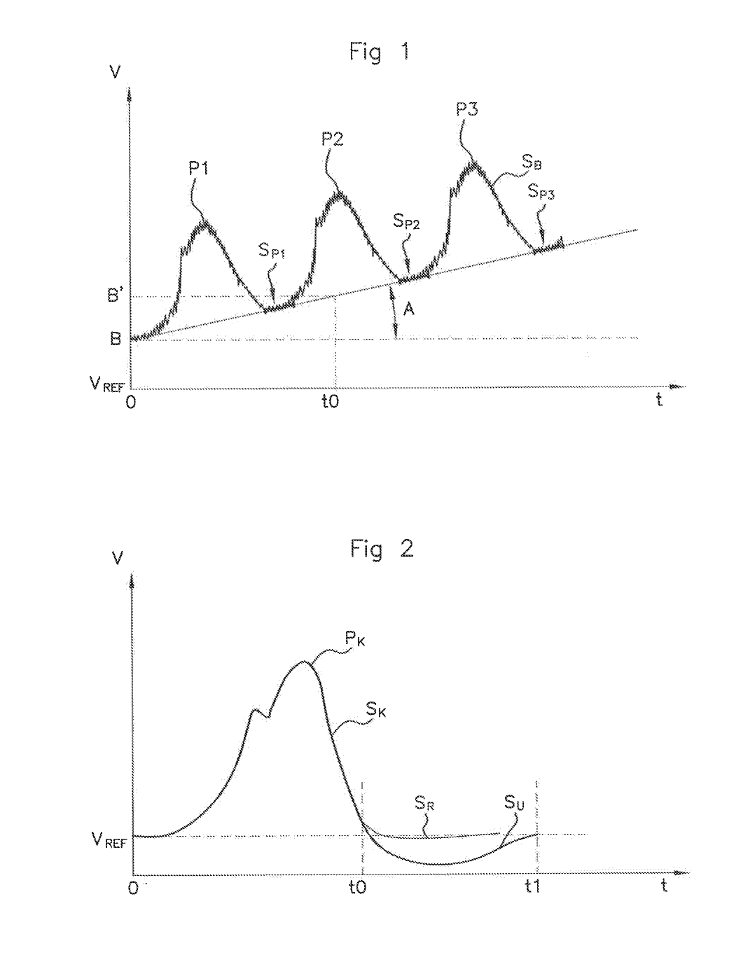

### DETAILED DESCRIPTION OF THE INVENTION

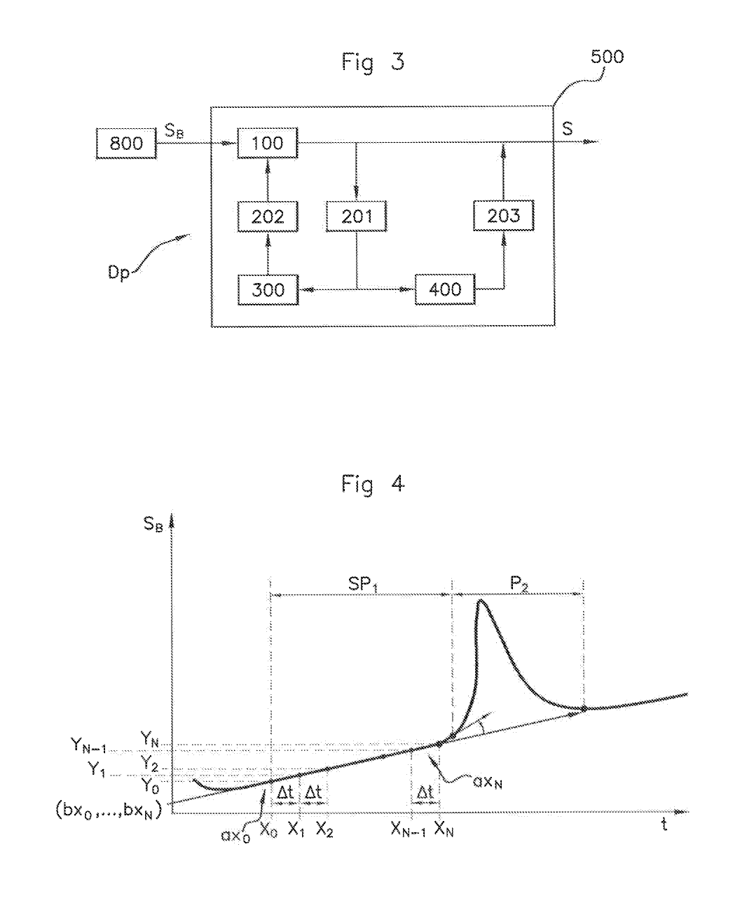

FIG. 3 shows an embodiment of the pressure measurement device D_{P} according to the invention. Such a measurement device D_{P} includes a pressure measurement sensor 800 connected to a processing unit 500.

Still with reference to FIG. 3, the output signal S_{B} of the pressure measurement sensor 800 is acquired and processed by the processing unit 500, for example built into an integrated circuit (ASIC, not shown in FIG. 3) in order to deliver a processed output signal S.

In this example, the processing unit 500 includes a charge amplifier 100, a first analog/digital converter 201, a second digital/analog converter 202, a third digital/analog converter 203, filtering means 300 and signal processing means 400.

The first analog/digital converter 201 is connected, on the one hand, to the charge amplifier 100 and, on the other hand, to the filtering means 302 and to the signal processing means 400.

The filtering means 300 filter the noise present on the signal S_{B} and are connected to the second digital/analog converter 202, itself connected to the charge amplifier 100. The filtering means 300 filter the noise present on the signal S_{B} by adding or removing compensation charges to/from the input signal S_{B} of the charge amplifier 100.

The signal processing means 400 include an offset correction algorithm, connected to the third digital/analog converter 203, delivering a processed output signal S to an electronic calculator (not shown).

As previously explained, the signal S_{B} from the pressure sensor 800 can be equated to an alternation of “plateau” phases S_{P1}, S_{P2}, Sₚ₃ (cf. FIGS. 1 and 4) during which the voltage is offset in relation to a reference value V_{REF} and changes according to a slope function A more or less linear as a function of time, and voltage peaks P1, P2, P3 representing combustion pressure peaks (cf. FIGS. 1 and 4).

According to the invention, the offset correction algorithm includes an algorithm for detecting the start and end of the voltage peaks representing combustion pressure peaks.

More precisely, with reference to FIG. 4, the signal processing means 400 are configured to detect the start of a plateau phase S_{P1}, S_{P2}, S_{P3} on the basis of at least one value Y₀, . . . , Y_{N} of the signal S_{B} acquired by the processing unit 500.

This detection is necessary in order to distinguish the voltage values belonging to the plateau phases from the voltage values belonging to the combustion pressure peaks.

In fact, the determination of the signal offset is possible only during the plateau phases, the abnormally high values of the combustion pressure peaks not allowing the determination of the offset.

This algorithm for detecting the start or end of the voltage peaks is based, for example, on the change in the slope of the signal from one acquisition time Xₙ to the next Xₙ₊₁.

Any abnormally and suddenly increased slope is then indicative of a start of a combustion pressure peak. Similarly, any gentle slope following the detection of a steep slope is characteristic of the end of a peak, i.e. the start of a plateau phase. Obviously, other signal voltage peak detection algorithms are possible and are known to the person skilled in the art, and will not be described in more detail here.

In order to improve this detection, it is known to prefilter the signal S_{B} by using a low-pass filter in order to remove potential interference and noise. It is also known to sample it at frequency lower than the frequency of acquisition of the output signal of the sensor 800 by the processing unit 500.

This sampling enables a reduction in the memory size of the ASIC dedicated to the method for processing the signal S_{B}. The filter and the sampling can be implemented by filtering means 300.

Moreover, still with reference to FIG. 4, for each value Y₀, . . . , Y_{N} of the output signal S_{B} of the sensor 800 acquired during the detected plateau phase S_{P1}, S_{P2}, S_{P3}, the signal processing means 400 are configured to:
calculate a pair of values of a slope ax₀, . . . , ax_{N} and an intercept bx₀, . . . , bx_{N} of a straight line approximating the values Y₀, . . . , Y_{N} of the signal S_{B} acquired by the processing unit during the plateau phase S_{P1}, S_{P2}, S_{P3},
determining a voltage compensation value Comp(Yₙ) for the signal S_{B} on the basis of each pair of calculated slope ax₀, . . . , ax_{N} and intercept bx₀, . . . , bx_{N} values,
compensating the signal S_{B} of the pressure sensor 800 on the basis of the determined voltage compensation value Comp(Yₙ).

The signal processing means 400 are also configured to detect the start of a voltage peak phase P1, P2, P3 following the plateau phase S_{P1}, S_{P2}, S_{P3}, and, during the detected peak phase P1, P2, P3, to compensate the signal on the basis of the last pair of slope ax_{N} and intercept bx_{N} values calculated during the plateau phase S_{P1}, S_{P2}, S_{P3}.

The invention proposes a method for processing the signal S_{B} of the pressure measurement device D_{P}. This method assumes the form of an algorithm which can be integrated, for example, and in a non-limiting manner, into the signal processing means 400 described above.

The method for processing the signal S_{B} aims to correct the offset of the signal in relation to the reference value V_{REF}.

The values of the signal S_{B} are acquired periodically, for example every AΔt=1/804 Hz=1.24 ms, by the processing unit 500.

According to the invention, with reference to FIGS. 1, 4 and 5, the start of a plateau phase S_{P1}, i.e. the end of a first peak P1, is detected, in a step E1, on the basis of at least one value of the signal S_{B} acquired by the processing unit 500.

This detection is based, for example, as mentioned above, on the change in the signal slope from one acquisition time Xₙ to the next Xₙ₊₁. Any abnormally and suddenly increased slope is then indicative of a start of a combustion pressure peak P1, P2, P3 and any gentle slope following a steep slope is characteristic of an end of a peak P1, P2, P3, i.e. of the start of a plateau phase S_{P1}, S_{P2}, S_{P3}.

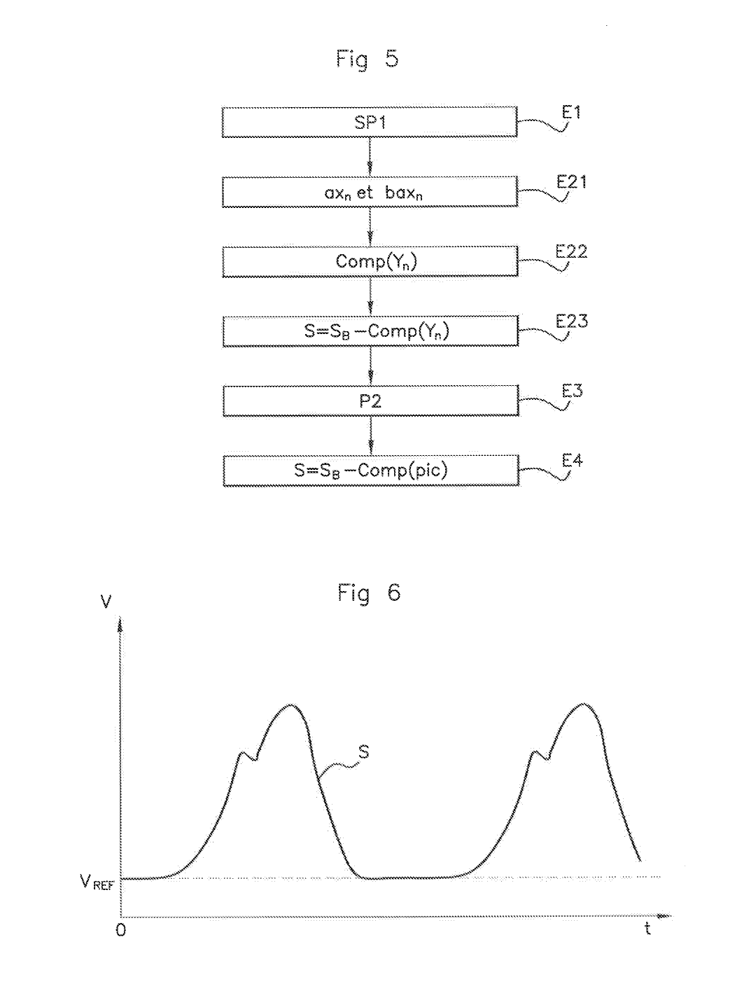

With reference to FIGS. 4 and 5, for each value of the signal S_{B} acquired at the output of the sensor 800 by the processing unit 500 corresponding to each acquisition time Xₙ (for n varying from 0 to N during a plateau phase) of the detected plateau phase S_{P1}, the method includes:
a step E21 of calculating a pair of values of a slope axₙ and an intercept bxₙ of a straight line approximating the values of the signal Y₀, . . . , Yₙ acquired by the processing unit during the plateau phase S_{P1},
a step E22 of determining a voltage compensation value Comp(Xₙ) of the signal S_{B} on the basis of each pair of calculated slope axₙ and intercept values bxₙ,
a step E23 of compensating the signal S_{B} from the pressure sensor on the basis of the determined voltage compensation value Comp(Yₙ),

The implementation of these three steps E21, E22 and E23 for each voltage value Yₙ of the signal S_{B} measured during the plateau phase S_{P1} and corresponding to the n+1 acquisition times Xₙ (for n varying from 0 to N during the plateau phase S_{P1}) enables the determination of a slope for all of these values through linear regression.

The compensation, which corresponds to the slope obtained through linear regression at the acquisition time Xₙ for n+1 measurement points of the plateau S_{P1}, thus corresponds to an average of slopes for the measurement points X₀ to Xₙ, and not to a single slope of a measurement point of which the value could be incorrect as it deviates too much from the average-slope straight line for the measurement points X₀ to Xₙ.

The known linear regression formulae define these coefficients as follows:

$$\begin{matrix}{ax}_{n} = \frac{{\sum }_{i = 0}^{n} ( {X}_{i} - {Xavg}_{n} ) \times ( {Y}_{i} - {Yavg}_{n} )}{{\sum }_{i = 0}^{n} {( {X}_{i} - {Xavg}_{n} )}^{2}} & ( 1 ) \\ {bx}_{n} = \frac{1}{n + 1} \times {\sum }_{i = 0}^{n} ( {Y}_{i} - {ax}_{n} \times {X}_{i} ) & ( 2 )\end{matrix}$$

where:
axₙ is the slope of the straight line at the time Xₙ,
bxₙ is the intercept of the straight line at the time Xₙ,
Xₙ is the time defined by (Xₙ₋₁+Δt) and X₀=0,
Yₙ is the value of the voltage signal measured at the output of the sensor 800 at the time Xₙ,
Xavgₙ is the mean value of the n samples of the signal Xᵢ, and
Yavgₙ is the mean value of the n samples of the signal Yᵢ.

In order to determine these coefficients, the slope axₙ is defined as follows:

$${ax}_{n} = \frac{{a}_{n} \times Δ t}{{\sum }_{i = 0}^{n} {( {X}_{i} - {Xavg}_{n} )}^{2}} \qquad ( 3 )$$

where:

αₙ×Δt=Σᵢ₌₀ⁿ[(Xᵢ−Xavgₙ)×(Yᵢ−Yavgₙ)] (4)

Δt being the measurement time interval between two acquisition times of the output signal of the sensor 800.

Yavgₙ and Yavgₙ₋₁ are defined by the following formulae:

$${Yavg}_{n} = \frac{1}{n + 1} {\sum }_{i = 0}^{n} {Y}_{i} and {Yavg}_{n - 1} = \frac{1}{n} {\sum }_{i = 0}^{n} {Y}_{i} with n > 0 \qquad ( 5 )$$

The following is obtained through recursion:

$${Yavg}_{n} = \frac{n \times {Yavg}_{n - 1} + {Y}_{n}}{n + 1} \qquad ( 6 )$$

Similarly, the following is defined:
Xᵢ=Δt+Xᵢ₋₁, Xᵢ=i×Δt, X₀=0 for i varying from 0 to n, hence:

$$\begin{matrix}{Xavg}_{n} = \frac{1}{n + 1} \times {\sum }_{i = 0}^{n} {X}_{i} \\ = \frac{1}{n + 1} \times {\sum }_{i = 0}^{n} i \times Δ t \\ = \frac{Δ t}{n + 1} \times {\sum }_{i = 0}^{n} i \\ = \frac{Δ t}{n + 1} \times \frac{n \times ( n + 1 )}{2}\end{matrix}$$

i.e.:

$${Xavg}_{n} = \frac{Δ t \times n}{2} \qquad ( 7 )$$

From which the following is inferred:

$$\begin{matrix}{\sum }_{i = 0}^{n} {( {X}_{i} - {Xavg}_{n} )}^{2} = {\sum }_{i = 0}^{n} {( i \times Δ t - \frac{Δ t \times n}{2} )}^{2} = \frac{Δ {t}^{2} \times ( n + 1 ) \times ( n + 2 )}{12} \\ and & ( 8 ) \\ {ax}_{n} = \frac{12 \times {a}_{n}}{Δ t \times n \times ( n + 1 ) \times ( n + 2 )} & ( 9 )\end{matrix}$$

Development of Equation (4) gives the following:

$$\begin{matrix}{a}_{n} \times Δ t = {\sum }_{i = 0}^{n} [ ( {X}_{i} - {Xavg}_{n} ) \times ( {Y}_{i} - {Yavg}_{n} ) ] \\ = {\sum }_{i = 0}^{n} [ ( i \times Δ t - \frac{Δ t \times n}{2} ) \times ( {Y}_{i} - {Yavg}_{n} ) ] \\ = Δ t \times {\sum }_{i = 0}^{n} [ ( i - \frac{n}{2} ) \times ( {Y}_{i} - {Yavg}_{n} ) ]\end{matrix}$$

i.e.:

$${a}_{n} = {\sum }_{i = 0}^{n} [ ( i - \frac{n}{2} ) \times ( {Y}_{i} - {Yavg}_{n} ) ] = {\sum }_{i = 0}^{n} [ ( i - \frac{n}{2} ) \times ( {Y}_{i} ) ] - {Yavg}_{n} {\sum }_{i = 0}^{n} [ ( i - \frac{n}{2} ) ]$$

$$therefore$$

$${\sum }_{i = 0}^{n} ( i - \frac{n}{2} ) = 0$$

hence:

$${a}_{n} = {\sum }_{i = 0}^{n} [ ( i - \frac{n}{2} ) \times ( {Y}_{i} ) ] \qquad ( 10 )$$

Similarly, considering aₙ₋₁:

$${a}_{n - 1} = {\sum }_{i = 0}^{n - 1} [ ( i - \frac{n - 1}{2} ) \times ( {Y}_{i} - {Yavg}_{n - 1} ) ] = {\sum }_{i = 0}^{n - 1} [ ( i - \frac{n - 1}{2} ) \times ( {Y}_{i} ) ] - {Yavg}_{n - 1} {\sum }_{i = 0}^{n - 1} [ ( i - \frac{n - 1}{2} ) ]$$

$$therefore$$

$${\sum }_{i = 0}^{n - 1} ( i - \frac{n - 1}{2} ) = 0$$

hence:

$${a}_{n - 1} = {\sum }_{i = 0}^{n - 1} [ ( i - \frac{n}{2} + \frac{1}{2} ) \times {Y}_{i} ] = {\sum }_{i = 0}^{n - 1} [ ( i - \frac{n}{2} ) \times {Y}_{i} ] + \frac{1}{2} \times {\sum }_{i = 0}^{n - 1} [ {Y}_{i} ] \\ {a}_{n - 1} = {\sum }_{i = 0}^{n - 1} [ ( i - \frac{n}{2} + \frac{1}{2} ) \times {Y}_{i} ] = {\sum }_{i = 0}^{n - 1} [ ( i - \frac{n}{2} ) \times {Y}_{i} ] + \frac{n}{2} \times {Yavg}_{n} \\ {\sum }_{i = 0}^{n - 1} [ ( i - \frac{n}{2} ) \times {Y}_{i} ] = {a}_{n - 1} - \frac{n}{2} \times {Yavg}_{n} \qquad ( 11 )$$

The sum of Equations (10) and (11) enables the following inference:

$${a}_{n} = {a}_{n - 1} - \frac{n}{2} \times {Yavg}_{n - 1} + \frac{n}{2} \times {Y}_{n} = {a}_{n - 1} + \frac{n}{2} \times ( {Y}_{n} - {Yavg}_{n - 1} ) \qquad ( 12 )$$

### Hence:

$${a}_{n} = {a}_{n - 1} + \frac{n}{2} \times {Y}_{n} - {Yavg}_{n - 1} )$$

$${ax}_{n} = \frac{12 \times {a}_{n}}{Δ t \times n \times ( n + 1 ) \times ( n + 2 )}$$

$${bx}_{n} = {Yavg}_{n} - Δ t \times {ax}_{n} \times \frac{n}{2}$$

$$( with {a}_{0} = 0 ) .$$

Moreover, the following is obtained:

$${bx}_{n} = \frac{1}{n + 1} \times {\sum }_{i = 0}^{n} ( {Y}_{i} - {ax}_{n} \times {X}_{i} ) \qquad ( 2 )$$

from which the following is inferred by developing:

$$\begin{matrix}( n + 1 ) \times {bx}_{n} = {\sum }_{i = 0}^{n} ( {Y}_{i} - {ax}_{n} \times {X}_{i} ) \\ = {\sum }_{i = 0}^{n} ( {Y}_{i} ) - {\sum }_{i = 0}^{n} ( {ax}_{n} \times i \times Δ t ) \\ = ( n + 1 ) \times {Yavg}_{n} - Δ t \times {ax}_{n} \times \frac{n \times ( n + 1 )}{2}\end{matrix}$$

i.e., by simplifying by (n+1):

$${bx}_{n} = {Yavg}_{n} - Δ t \times {ax}_{n} \times \frac{n}{2} \qquad ( 13 )$$

During the plateau phase S_{P1}, for the value Yₙ of the signal S_{B} acquired at the time Xₙ of the plateau phase S_{P1}, the voltage compensation value Comp(Yₙ) of the sensor output signal is given by: Comp(Yₙ)=Yₙ.

In other words, during the plateau phase, the signal S_{B} of the sensor is compensated by the value Comp(Yₙ)=Yₙ.

At the output of the processing unit 500, the value of the signal thus compensated, i.e. the processed signal S, is therefore given by:

S=S_{B}−Comp(Yₙ) (14)

An offset voltage Vref, for example in the region of 500 mV, can be added to the value of the processed signal S, this value from the sensor 800 being arbitrary, given that the sensor is a relative pressure sensor.

This compensation step E23 can be followed by a low-pass filtering step in order to eliminate the residual noise.

In parallel with the steps E21, E22 and E23, a step E3 of detecting the start of a second peak P2 following the plateau S_{P1} is carried out in order to determine the end of the plateau for which the last acquisition time is implemented by the processing unit 500 at the time Xₙ for which a slope ax_{N} and an intercept bx_{N} are calculated by the processing unit 500.

When the start of a peak following P2 is detected following the last acquisition time X_{N}, the compensation of the output signal S_{B} is implemented, in a step E4, on the basis of the last slope and intercept values calculated at the last acquisition time Xₙ of the plateau phase S_{P1}.

Thus, the positive-slope straight line obtained through linear regression on the N+1 voltage values measured for the N+1 measurement points has the slope ax. The signal value to be subtracted during the peak phase P2 to compensate the offset is as follows:

Comp(pic)=Δx_{N}×X_{N}+bx_{N} (15)

and the value of the processed output signal S of the processing unit 500 is given by

S=S_{B}−Comp(pic) (16)

An interpolation is therefore carried out during the peak phase on the basis of the last parameters ax_{N} and bx_{N} calculated by the processing unit 500 through linear regression during the plateau phase SP₁.

This compensation step E4 can be followed by a low-pass filtering step in order to eliminate residual noise.

The method according to the invention is repeated for each plateau phase and for each peak phase in such a way that the processing unit 500 continuously compensates the output signal S_{B} of the sensor 800 as shown schematically in FIG. 6.

1. A method for processing a signal from a pressure measurement device (D_{P}) in a combustion chamber of a cylinder of an internal combustion engine, said device including:
a pressure measurement sensor (800) supplying an output voltage signal (S_{B}) representing the pressure within said combustion chamber, the signal (S_{B}) alternately including “plateau” phases (S_{P1}, S_{P2}, S_{P3}) during which the voltage changes according to a more or less linear function as a function of time, and voltage peak phases (P1, P2, P3) representing pressure peaks in the combustion chamber, and
a processing unit (500) connected to said pressure measurement sensor (800) and configured to acquire periodically a plurality of values (Y₀, . . . , Y_{N}) of the output voltage signal (S_{B}) of the sensor (800),
and the method including the following steps:
a step of detection (E1) of the start of a plateau phase (S_{P1}, S_{P2}, S_{P3}) on the basis of at least one value (Y₀, . . . , Y_{N}) of the signal (S_{B}) acquired by the processing unit (500),
for each value (Y₀, . . . , Y_{N}) of the output signal (S_{B}) of the sensor (800) acquired during the detected plateau phase (S_{P1}, S_{P2}, S_{P3}):
a step (E21) of calculating a pair of values of a slope (ax₀, . . . , ax_{N}) and an intercept (bx₀, . . . , bx_{N}) of a straight line approximating the values (Y₀, . . . , Y_{N}) of the signal (S_{B}) acquired by the processing unit (500) during the plateau phase (S_{P1}, S_{P2}, S_{P3}),
a step (E22) of determining a voltage compensation value (Comp (Yₙ)) of the signal (S_{B}) on the basis of each pair of calculated slope (ax₀, . . . , ax_{N}) and intercept (bx₀, . . . , bx_{N}) values,
a step (E23) of compensating the signal (S_{B}) from the pressure sensor (800) on the basis of the determined voltage compensation value (Comp(Yₙ)),
a step (E3) of detecting the start of a voltage peak phase (P1, P2, P3) following the plateau phase (S_{P1}, S_{P2}, S_{P3}), and,
during the detected peak phase (P1, P2, P3), a step (E4) of compensating the signal on the basis of the last pair of slope (ax_{N}) and intercept (bx_{N}) values calculated during the plateau phase (S_{P1}, S_{P2}, S_{P3}),
said method being characterized in that the slope value (ax₀, . . . , ax_{N}) and the intercept value (bx₀, . . . , bx_{N}) for a value (Y₀, . . . , Y_{N}) of the output signal (S_{B}) of the sensor (800) acquired at the time n, n varying from 0 to N, are given respectively by:
$${ax}_{n} = \frac{12 \times {a}_{n}}{Δ t \times n \times ( n + 1 ) \times n + 2 )}$$
$$with$$
$${a}_{n} = {a}_{n - 1} + \frac{n}{2} \times ( {Y}_{n} - {Yavg}_{n - 1} )$$
and a₀=0, and,
$${bx}_{n} = {Yavg}_{n} - Δ t \times {ax}_{n} \times \frac{n}{2}$$
where:
$${Yavg}_{n} = \frac{n \times {Yavg}_{n - 1} + {Y}_{n}}{n + 1} with {Yavg}_{0} = {Y}_{0}$$
and where:
Yavgₙ is the mean value of the output signal (S_{B}) of the sensor (800) acquired by the processing unit (500) at the time n, Yavgₙ₋₁ is the mean value of the output signal (S_{B}) of the sensor (800) acquired by the processing unit (500) at the time n−1,
the coefficient aₙ is given by:
$${a}_{n} = {a}_{n - 1} + \frac{n}{2} \times ( {Y}_{n} - {Yavg}_{n - 1} )$$
Yₙ is the value of the output signal (S_{B}) of the sensor (800) acquired at the time n,
Δt corresponds to the period of acquisition of the values (Y₀, . . . , Y_{N}) of the output signal (S_{B}) of the sensor (800) by the processing unit (500).

2. The method as claimed in claim 1, characterized in that the calculation step (E21) is carried out through linear regression.

3. The method as claimed in claim 1, characterized in that the step (E4) of compensating the output signal (S_{B}) of the sensor (800) during the detected peak phase (P1, P2, P3) is carried out for each acquisition time (X₀, . . . , X_{N}) of said signal (S_{B}).

4. The method as claimed in claim 1, characterized in that the values of the signal (S_{B}) are acquired every 1/804 Hz=1.24 ms.

5. The method as claimed in claim 2, characterized in that the step (E4) of compensating the output signal (S_{B}) of the sensor (800) during the detected peak phase (P1, P2, P3) is carried out for each acquisition time (X₀, . . . , X_{N}) of said signal (S_{B}).

6. The method as claimed in claim 2, characterized in that the values of the signal (S_{B}) are acquired every 1/804 Hz=1.24 ms.

7. The method as claimed in claim 3, characterized in that the values of the signal (S_{B}) are acquired every 1/804 Hz=1.24 ms.
